(19) United States
(12) Patent Application Publication
(10) Pub. No.: US 2022/0260394 A1
(43) Pub. Date: Aug. 18, 2022

(54) PHASE DEMODULATION BY FREQUENCY CHIRPING IN COHERENCE MICROWAVE PHOTONIC INTERFEROMETRY

(71) Applicant: CLEMSON UNIVERSITY, Clemson, SC (US)

(72) Inventors: LIWEI HUA, CLEMSON, SC (US); HAI XIAO, CLEMSON, SC (US); LAWRENCE C. MURDOCH, CLEMSON, SC (US)

(21) Appl. No.: 17/584,017

(22) Filed: Jan. 25, 2022

Related U.S. Application Data
(60) Provisional application No. 63/148,850, filed on Feb. 12, 2021.

(51) Int. Cl. G01D 5/353; G01M 7/02; G01H 9/00

(52) U.S. Cl. CPC G01D 5/35332; G01H 9/004; G01M 7/025

(57) ABSTRACT

Systems and methods of signal processing for sensors are disclosed. Signal processing methods and systems demodulate the optical interference phase of cascaded individual optical fiber intrinsic Fabry-Perot interferometric sensors in a coherent microwave-photonic interferometry distributed sensing system. The chirp effect of an electro-optic modulator (EOM) is used to create a quasi-quadrature optical interference phase shift between two adjacent pulses which correspond to two adjacent reflection points in the time domain. The phase shift can be controlled by adjusting the bias voltage that is applied to the EOM. The interference phase is calculated by elliptically fitting the phase shift. The interference phase change is proportional to the optical path difference (OPD) change of the interferometer, and the sign can be used to differentiate the increase or decrease of the OPD. The approach shows good linearity, high resolution, and large dynamic range for distributed strain sensing.

### PRIORITY CLAIM

The present application claims the benefit of priority of U.S. Provisional Patent Application No. 63/148,850, titled “Phase Demodulation by Frequency Chirping in Coherence Microwave Photonic Interferometry,” filed Feb. 12, 2021, which is incorporated herein by reference for all purposes.

### GOVERNMENT SUPPORT CLAUSE

This presently disclosed subject matter was made with government support under Grant DE-FE0028292, awarded by U.S. Department of Energy. The government has certain rights in the presently disclosed subject matter.

### FIELD

The present disclosure relates generally to signal processing for interferometric sensors. The present disclosure also relates to concepts of distributed sensing, static measurement, distributed acoustic sensing (DAS), optical interference, and frequency domain. More particularly, the present subject matter relates to a signal processing method to demodulate the optical interference phase of cascaded individual optical fiber intrinsic Fabry-Perot interferometric (IFPI) sensors in a coherent microwave-photonic interferometry (CMPI) distributed sensing system.

### BACKGROUND

High-sensitivity distributed sensing method for both dynamic and static measurement is needed for structural health monitoring, seismic wave detection, and in situ underground deformation monitoring for geophysics and geotechnical applications.

Electrical strain gauges or other electromagnetic sensors have been used for many years in these areas, but optical fiber sensors have made major inroads in recent decades. Fiber Bragg Gratings (FBGs) are the most common optical fiber sensor for measuring strain. This technology uses gratings etched over a cm or so of the fiber to measure strain, and a few dozen gratings can be used along the same fiber to measure strain at multiple locations. The resolution of FBGs is limited to approximately 10 microstrain. This is sufficient to characterize fairly large deformations, but it is too coarse to measure subtle changes that have been shown to be important. The small size of FBGs means that their measurements are highly localized. This is useful for some applications, but in other applications, the strain may vary at the cm scale and the averaging caused by a longer measurement baseline would be more representative. FBGs are typically sampled at rates of approximately 1 Hz, which is sufficient to measure slow strains (for example, associated with the bending of a bridge girder), but it is too slow to be useful for seismic or acoustic applications where strains occur at frequencies of tens to thousands of Hz.

Time domain reflectometry distributed sensors utilize the intensity of backscatter light, with Raman and/or Brillouin peaks in the light signal to measure temperature, strain, or pressure. These distributed sensors offer a number of advantages including continuous sensing along the entire length of fiber, and flexibility and simplicity of the sensor, which may be standard telecoms optical fiber. Raman peaks are only sensitive to the temperature change, so it has been utilized for low-rate distributed temperature sensing (DTS). A typical performance of DTS is 1 m-10 m spatial resolution and 1° C. temperature resolution over 10 km range. Brillouin peak shifting has been used to measure distributed strain. Due to the low strain sensitivity of 1 MHz/10 μϵ, Brillouin peak shifting only provides strain resolution of 10 μϵ. These methods all rely on a wavelength scanning, and the measurement times are typically in order of a few seconds to minutes, so they are also too slow for the seismic or acoustic applications.

Phase optical time domain reflectometry (ϕOTDR) uses a coherent light source in a traditional OTDR system. The optical interference of the distributed Rayleigh scatterings within the duration of the light pulse is collected and processed. The response of ϕOTDR systems has been limited by a number of parameters such as polarization and signal fading phenomena; the random variation of the backscatter light; and nonlinear coherent Rayleigh response. Therefore, these techniques are mainly used for event detection and do not provide quantitative measurements, such as the measurement of acoustic amplitude, frequency, and phase over a wide range of frequency and dynamic range.

Distributed Acoustic Sensing (DAS) was recently developed based on the modified ϕOTDR, where an optical fiber with weak reflectors arrays is used as the sensing element. The transfer function of the weak reflector array can be directly correlated with the localized strain change. The DAS system developed by this technology was used to measure seismic signals, and this application has attracted considerable attention in the oil industry where it promises to reduce costs and improve resolution when exploring for oil reservoirs.

Current DAS methods measure strain rates in the 1 Hz-100 kHz range, and some applications can resolve frequencies as low as 0.001 Hz. One disadvantage of DAS is that it requires expensive equipment, which in many cases is closely held by the companies who developed it. These companies provide this equipment with an operator as a service, which is expensive. The strain rate data generated by this equipment must be integrated in time over a 10-m-long-to-baseline calculate strain. In this case, the long baseline can be useful for some applications where averaging is desired, but it is problematic in other applications where sharper spatial resolution is needed. Considerable computational processing is required to determine strains from strain rates, and computational stacking of multiple datasets is used in an effort to improve resolution. The computations needed to process data have improved the resolution of DAS, but it has made calibration and validation difficult.

Recently, we reported a distributed fiber optic sensing system based on CMPI in which a microwave modulated coherent light source is used to interrogate cascaded fiber optic IFPI^{[1]}. In the system, the microwave signal is used to find the locations of the interferometers, the optical interference signals are used to find the optical path difference (OPD) changes of the interferometers, which can be correlated to the localized small structure deformation (e.g., strain and pressure) or temperature changes. Because optical interference can measure very small OPD changes, CMPI offers the key advantage of distributed measurement with very high sensitivity. Among many other applications, CMPI has great potential for geophysical applications, such as monitoring underground deformation during CO₂ injection^{[2]}, which requires spatially continuous distributed measurement of strain with high sensitivity.

In its implementation, the reported CMPI distributed sensing system scans the microwave frequencies to acquire the complex microwave spectrum, which is then converted to time domain signals by complex Fourier Transform. The distributed interferometers are shown as individual pulses in the time domain signal. The amplitudes of these time-domain pulses change sinusoidally as a function of the OPDs of the respective interferometers[¹]. Due to the sinusoidal nature of the optical interference signal, the intensity of the signal is a nonlinear function of OPD. This nonlinear amplitude-OPD relation imposes difficulty in sensing in the following ways: First, the measurement sensitivity is nonlinear, maximum in the quadrature region of the sinusoidal curve and becomes minimum at the peak or valley of the curve. Second, the amplitude-based measurement requires a calibration to establish the amplitude-OPD relation. Third, the amplitude is prone to noise and could be distorted by polarization fading, especially when the interferometers have a long cavity^{[3]}.

A more accurate way to read the interferometers is based on the phase of the optical interference as the phase is a linear function of OPD. The homodyne quadrature phase shift (QPS) method has been widely used to unwrap the phase of an optical interferometer^{[4]}. In the homodyne QPS, two interference signals are generated simultaneously, and these two signals have a phase difference of 90° ideally, one designated as the in-phase signal (I) and the other as the quadrature (Q). In a more general (or non-ideal) case, the phase difference between the two signals is not exactly 90°, and they may have different contrast (i.e., fringe visibility) and DC levels^{[5,6]}. The phase of the interferometer—which is proportional to the OPD—can be derived from orthogonal demodulation algorithm and phase unwrapping^{[4]}. A typical approach of homodyne phase-shifted detection for interferometric fiber optic sensors signal demodulation requires multiple detectors^{[7]-[9]}. In one demodulation scheme, four birefringence crystals with different thicknesses were used before detectors to obtain the quadrature phase-shifted signals[¹⁰]. Another demodulation scheme is to use 3×3 coupler to generate phase shifted signals simultaneously^{[9]}. These methods allow high speed demodulation, but the detection systems are relatively complicated.

Digital homodyne phase-shifted detection schemes use unsymmetrical configuration in the digital domain to create two orthogonal interference signals and differentiate them through novel signal processing method^{[11]-[13]}, so the detection is simplified. In one study, an orthogonal demodulation algorithm was used to demodulate the interference phase of a binary phase modulation was imposed on the laser source of a fiber interferometer to generate a wave with three phase shifting radians at output^{[11]}. In yet another study, a frequency-modulated (FM) single sideband (SSB) carrier signal is generated, and system sampling rate to 12 times of the FM frequency is adopted for the generation of two orthogonal signals for arctangent transformation^{[13]}. Those methods show high phase shifting detection resolution, but it is challenging to directly apply them in the distributed sensing system.

Some conventional homodyne detection methods have been adopted in phase-OTDR and phase-OFDR distributed sensing systems^{[14],[15]}. In one example, a 3×3 coupler has been used to simultaneously obtain three interference signals that are separated azimuthally by 120°^{[16], [17]}. In another example, a 90° optical hybrid is used to obtain the in-phase and quadrature components^{[15]}. A recent study shows that digital homodyne quadrature detection can be realized in phase-OTDR by using different parts of the time pulse^{[18]}.

### SUMMARY

Motivated by these successes in applying homodyne detection for distributed sensing, we conducted a study on implementing the homodyne quadrature detection method to demodulate the phase of cascaded interferometers in a CMPI distributed sensing system. To avoid adding new components into the CMPI system, our method utilizes the chirp effect of an electro-optic modulator (EOM) to create the two quadrature interference signals. In addition to its simple configuration, we find that the EOM chirp-based method allows us to fine tune to the desired 90° phase shift by simply adjusting the bias of the EOM.

In general, it is a present object to provide improved signal processing arrangements and associated methodology.

One presently disclosed exemplary embodiment of the presently disclosed subject matter relates to methodology for signal processing. Such methodology preferably may comprise methodology for signal processing for CMPI sensors, including demodulating the optical interference phase of cascaded individual optical fiber IFPI sensors in a CMPI-distributed sensing system, including performing phase demodulation by frequency chirping.

Another presently disclosed exemplary embodiment relates to a method of using homodyne quadrature detection to demodulate the phase of cascaded interferometers in a CMPI-distributed sensing system comprising using the chirp effect of an EOM to create the two quadrature interference signals of the cascaded interferometers.

It is to be understood that the presently disclosed subject matter equally relates to associated and/or corresponding apparatuses and/or systems. One exemplary such system relates to a CMPI-based distributed sensing system for accurately measuring static and dynamic changes of physical, chemical, or biological property, comprising an optical fiber with a series of weak reflectors along it, with any two of such reflectors forming an FPI recording the localized change in distance between the two reflectors in the form of optical interference; a coherent microwave photonics interrogation unit configured to prepare a microwave-modulated low-coherence light wave from a light source; and one or more processors programmed to control the sensing system to scan microwave frequencies to obtain complex microwave spectrum frequency domain measurements.

Other example aspects of the present disclosure are directed to systems, apparatus, tangible, non-transitory computer-readable media, user interfaces, memory devices, and electronic devices for determining characteristics of a dielectric material. For example, devices and/or apparatuses of the presently disclosed subject matter may involve one or more processors and one or more non-transitory computer-readable media that store instructions that, when executed by the one or more processors, cause the one or more processors to perform operations.

A CMPI-based distributed sensing technique for accurately measuring static and dynamic changes of physical, chemical, or biological property is described. The sensing system includes an optical fiber with a series of weak reflectors along it and a coherent microwave photonics interrogator. Any two reflectors form an FPI, which records the localized change in distance between the reflectors in the form of optical interference. The microwave photonics interrogation unit is configured to prepare a microwave-modulated low-coherence light wave. By scanning the microwave frequencies, the complex microwave spectrum is obtained and converted to a time domain signal at a known location by complex Fourier transform. The values of these time domain pulses are a function of the OPDs of the distributed FPIs, which are used to read the displacement between pairs of measurement reflectors. As the microwave frequency is swept with a constant speed, the sub-scan rate interference intensity modulation due to acoustic/vibration is recorded in the complex microwave spectrum. Fourier transform converts the complex microwave spectrum to time domain pulses at known interferometer locations, and the created intensity modulation is converted into paired side lobes to the respective time domain pulse. The vibration frequency and amplitude at each location can be read from the respective time pulses and side lobes.

The presently disclosed subject matter features the following distinctive features:

1. High signal-to-noise ratio (SNR): The presently disclosed subject matter is based on frequency domain measurement, which provides much higher signal-to-noise ratio compared to approaches based on time domain measurement, and therefore, average over time is not needed.

2. High measurement resolution: The measurement resolution is proportional to the separation distance between two reflectors which form the FPI. The method provides sensing resolution of 1 part per billion (ppb) when the cavity length of FPI exceeds 1 m long. The measurement resolution is thousands of times higher than the distribute sensing technology that relies on reading the peak wavelength shifting of FBGs, or Raman and/Brillouin scattering.

3. Coherence gating for distributed sensing: The coherence length of the light source performs as the gate, which only allows the reflectors with separation distance smaller than the coherence length to contribute to the amplitude of the time domain pulse at each respective location. This allows distributed sensing to be achieved.

4. External interferometer for spatial continuous sensing: An EI with a cavity length equal to the spacing of the FPIs can be added into the system. The coherence length of the light source is only needed to cover the OPD difference between the EI and FPI. Therefore, the coherence length of the light wave can be much smaller than the OPD of each FPI, and no separations between adjacent FPIs is needed to perform fully distributed sensing. Wavelength drifting from the light source can be compensated by using an EI to achieve accurate strain reading. The spatial resolution and strain sensitivity can be adjusted by changing the cavity size of EI; therefore, the EI provides a flexible operation to look into different strain ranges. As the coherence length of light source is separated and the input light power is two independent parameters for the light source, the SNR of the system has low dependence on the spatial resolution. OTDR-type distributed sensing technologies use the width of time domain pulse to separate the sensing sections in space. The pulse width is inverse proportional to the spatial resolution but proportional to the SNR of a single time measurement, so systems have to compromise the dynamic measurement speed or/and SNR to achieve high spatial resolution.

5. Phase unwrapping by using frequency chirping: The chirp effect of EOM is utilized to create two interference signals in quadrature for each FPI, thus allowing the phase to unwrap the phase of each FPI, which has a linear relationship with OPD of the FPIs. This further avoids adding more optics into the system for coherence detection, which has been used in most of the OTDR type of technologies.

6. Sub-scan rate dynamic measurement: Dynamic information can be recorded during the frequency scanning and revealed after Fourier transform in time domain. Therefore, this method can be also used for distributed acoustic sensing. The dynamic measurement capability is competitive or superior to the TDR type of technologies, and it also allows the higher SNR for the static strain reading.

The presently disclosed technology can be used, for example, in applications involving high resolution static strain sensitivity, distributed acoustic sensing, long distance, and/or high spatial resolution.

This new CMPI method could be used in markets related to the structural health of buildings or civil infrastructure, such as bridges, roads, or dams; to monitoring geologic hazards, such as landslides or earthquakes; the safety and monitoring of underground resource management, such as oil and gas production, geothermal energy, carbon storage, water production or remediation; and to the characterization of the subsurface, or surface structures using seismic or acoustic methods.

In contrast to current DAS, CMPI measures strain directly so the integration step required by DAS is avoided. Moreover, the strain measurements between CMPI reflectors can be calibrated, and thus, both the location and spatial resolution are known. This makes it possible for CMPI to measure sharper spatial resolution with a clearly defined uncertainty, which is a significant advantage over DAS when making critical measurements. Further, compared with phase-OTDR, the presently disclosed subject matter uses continuous light wave instead of light pulses, and it measures the signal in frequency domain, so it has much higher SNR, which could significantly reduce the signal processing time and allow static strain measuring without averaging.

Phase unwrapping is performed by using the chirp effect of intensity modulator other than adding complex coherence detection into system. This detection hardware is much simpler than that of ϕ-OTDR. ϕ-OTDR uses pulse width as the gate function to separate the sensing information in space. Longer pulses come with larger pulse power, thus resulting in higher SNR but coarser spatial resolutions. The SNR is proportional to the measurement range and the fastest measurable signal rate; therefore, there is a tradeoff among spatial resolution, measurement range, and measurement rate. However, CMPI uses continuous light source. The coherence length of the light source performs as a gate function, and thus the output power of the light source is not directly related to the coherence length, so the measurement range and SNR of the system are not limited to the spatial resolution of the system and vice versa.

OFDR has a measurement range of hundreds of meters, which is limited by the coherence length of the light source. The dynamic measurement rate of OFDR is limited by the wavelength scanning rate of the laser source; however, CMPI could have a measurement range of more than 100 km, and the dynamic measurement rate could be as high as 100 kHz.

Perhaps the biggest advantage, however, is the cost of implementation. DAS uses electronic equipment that cost several $100,000, whereas CMPI can be implemented using interrogation equipment that costs $15,000-$20,000. The interrogator required for CMPI can be fabricated from common, off-the-shelf components. It would be possible for investigators to make their own interrogator for CMPI, but some expertise in optics would be required and we expect that most users would prefer to buy a functional interrogator. As a result, we expect commercial opportunities for CMPI would include a market for the interrogator, and we expect the cost of this device could be significantly less than the cost of a DAS interrogator.

The resolution of the CMPI can be several orders of magnitude greater than that of FBGs, and it can be designed to function with a wide range of baselines (the spacing between the reflectors). We have demonstrated spacings of approximately 2 cm (which is similar to an FBG array) to approximately 1 m. Moreover, CMPI can measure strains that range from essentially static to dynamic strains up to 100 kHz.

Additional objects and advantages of the presently disclosed subject matter are set forth in, or will be apparent to, those of ordinary skill in the art from the detailed description herein. Also, it should be further appreciated that modifications and variations to the specifically illustrated, referred and discussed features, elements, and steps hereof may be practiced in various embodiments, uses, and practices of the presently disclosed subject matter without departing from the spirit and scope of the subject matter. Variations may include, but are not limited to, substitution of equivalent means, features, or steps for those illustrated, referenced, or discussed, and the functional, operational, or positional reversal of various parts, features, steps, or the like.

Still further, it is to be understood that different embodiments, as well as different presently preferred embodiments, of the presently disclosed subject matter may include various combinations or configurations of presently disclosed features, steps, or elements, or their equivalents (including combinations of features, parts, or steps or configurations thereof not expressly shown in the figures or stated in the detailed description of such figures). Additional embodiments of the presently disclosed subject matter, not necessarily expressed in the summarized section, may include and incorporate various combinations of aspects of features, components, or steps referenced in the summarized objects above, and/or other features, components, or steps as otherwise discussed in this application. Those of ordinary skill in the art will better appreciate the features and aspects of such embodiments, and others, upon review of the remainder of the specification, and will appreciate that the presently disclosed subject matter applies equally to corresponding methodologies as associated with practice of any of the present exemplary devices, and vice versa.

These and other features, aspects and advantages of various embodiments will become better understood with reference to the following description and appended claims. The accompanying figures, which are incorporated in and constitute a part of this specification, illustrate embodiments of the present disclosure and, together with the description, serve to explain the related principles.

### BRIEF DESCRIPTION OF THE DRAWINGS

A full and enabling disclosure of the presently disclosed subject matter, including the best mode thereof, directed to one of ordinary skill in the art, is set forth in the specification, which makes reference to the appended figures, in which:

FIG. 1 is a schematic illustration of coherent microwave-photonics interferometry (CMPI);

FIG. 2 graphically illustrates phase shift of the interferometer as a function of γ₂/γ₁ at different ΔØ;

FIG. 3 graphically illustrates phase shift of the interferometer versus ΔØ under difference γ₂ /γ₁;

FIG. 4 is a schematic illustration of the presently disclosed experimental setup;

FIGS. 5A and 5C illustrate graphs of normalized time signals under different EOM bias voltages using an incoherent ASE source (FIG. 5A) and a coherent DFB laser (FIG. 5C), respectively;

FIGS. 5B and 5D illustrate graphs of normalized values (real parts of the complex values) of the pulse peaks as a function of the applied bias voltage to the EOM using an incoherent ASE source (FIG. 5B) and a coherent DFB laser (FIG. 5D), respectively;

FIGS. 6A and 6B illustrate graphs of normalized two peaks (black) and fitted ellipses (red) under the bias voltages of 1 V (FIG. 6A) and 6 V (FIG. 6B), respectively;

FIG. 6C illustrates a graph of phase shift p₀ calculated based on the fitted ellipse (FIG. 6B) at different bias voltages;

FIG. 7A illustrates a graph of normalized peak values (real part) of the two pulses as a function of the applied strains;

FIG. 7B illustrates a graph of unwrapped interference phase change as a function of applied strain;

FIG. 7C illustrates a graph of fitting residuals of the unwrapped interference phase;

FIG. 8A illustrates a graph of typical amplitudes of the time domain signals of the distributed sensors;

FIG. 8B illustrates a graph of normalized real part of the two peaks of the 1 m-long IFPI (upper) and 2 m-long IFPI (lower) as functions of time;

FIG. 8C illustrates a graph of fitted ellipses of the two cascaded IFPIs; and

FIG. 8D illustrates a graph of unwrapped interference phases of the two IFP Is as functions of time.

Repeat use of reference characters in the present specification and drawings is intended to represent the same or analogous features or elements or steps of the presently disclosed subject matter.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

### Description of the Method

Systems and methods of signal processing for sensors are disclosed. Signal processing methods and systems demodulate the optical interference phase of cascaded individual optical fiber IFPI sensors in a CMPI-distributed sensing system. The chirp effect of an EOM is used to create a quasi-quadrature optical interference phase shift between two adjacent pulses which correspond to two adjacent reflection points in the time domain. The phase shift can be controlled by adjusting the bias voltage that is applied to the EOM. The interference phase is calculated by elliptically fitting the phase shift. The interference phase change is proportional to the optical path difference (OPD) change of the interferometer, and the sign can be used to differentiate the increase or decrease of the OPD. The approach shows good linearity, high resolution, and large dynamic range for distributed strain sensing.

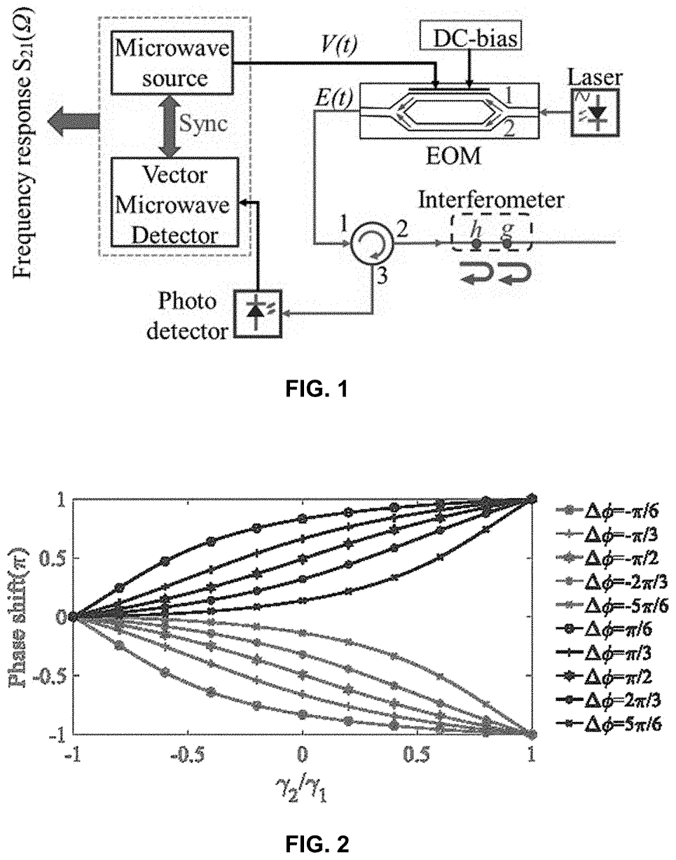

FIG. 1 is a schematic illustration of CMPI. A CMPI system uses an intensity-modulated light to interrogate cascaded interferometers. Let's assume a Mach-Zehnder type EOM is used to modulate the intensity of the light wave as schematically shown in FIG. 1, where the input light with the amplitude of the electric field of E₀ is evenly split between two arms of the EOM. The electric fields of the lights exiting the two arms can be expressed as^{[19]}:

E₁(t)=½E₀ exp j[ωt+Ø₀+γ₁·V(t)]

E₂(t)=½E₀ exp j[ωt+Ø₀+ΔØ+γ₂·V(t)], (1)

where ω is the optical frequency, Ø₀ and Ø₀+ΔØ are the static phase delays of the light paths through the two arms, respectively.

The static phase difference (SPD) ΔØ can be adjusted by tuning the DC-bias voltage from the DC source. γ₁ and γ₂ are the voltage-to-phase conversion coefficients for the two arms, respectively, which are assumed to be constant with respect to the applied modulation voltage V(t). If a sinusoidal modulation V(t)=V₀ sin(Ωt) is applied to the EOM, where Ω is the modulation frequency. The electric field at the output port of EOM is the superposition of the two arms, expressed as:

E(t)=E₁(t)+E₂(t)=½E₀ exp j(ωt+Ø₀)·{+exp jΔØ·exp j[α₂ sin(Ωt)]} (2)

where α₁₍₂₎=V₀·γ₁₍₂₎.

When this intensity modulated light from the EOM is used to interrogate an IFPI formed by two reflectors (h and g) with their reflectivity of Aₕ and A_{g}, respectively, as shown in FIG. 1, the light waves reflected from the two reflectors are expressed as:

$${E}_{h ( g )} ( t ) = \frac{1}{2} {E}_{0} {A}_{h ( g )} exp j ( ω t + {∅}_{0} - {∅}_{h ( g )} ) \cdot \{ + exp j Δ ∅ \cdot exp j [ {a}_{2} sin ( Ω t ) - {Φ}_{h ( g )} ] \} \qquad ( 3 )$$

$$where {∅}_{h ( g )} = \frac{ω {nz}_{h ( g )}}{c} and {Φ}_{h ( g )} = \frac{Ω {nz}_{h ( g )}}{c}$$

are the optical/microwave phases corresponding to the optical/microwave distances between the EOM and the photodetector as the two beams are reflected from h and g, respectively.

Eq. (3) can be Fourier decomposed into Bessel function sidebands given by:

$${E}_{h ( g )} ( t ) = \frac{1}{2} {E}_{0} \cdot exp j ( ω t + {∅}_{0} - {∅}_{h ( g )} ) \cdot {\sum }_{k = - ∞}^{∞} [ {J}_{k} ( {a}_{1} ) + {J}_{k} ( {a}_{2} ) ] ( k Ω t - {Φ}_{h ( g )} ) \qquad ( 4 )$$

where Jₖ(α_{1,2}) is the k-th order Bessel function.

Under the assumption of weak modulation, the contributions of the high order Bessel functions can be neglected. As α_{1,2}<<1, we can further assume J₀(α_{1,2})≈1, J₁(α_{1,2})≈a_{1,2}/2^{[20]}, and Eq. (4) can be approximated by keeping the low orders (DC and the fundamental frequency only, or linear approximation) Bessel functions, given by:

E_{h(g)}(t)≈½E₀A_{h(g)} exp j(ωt+Ø₀−Ø_{h(g)})·{1+exp j(ΔØ)+j[α₁+α₂(ΔØ)]sin(Ωt−Φ_{h(g)})} (5)

The received optical power at the photodetector is approximately expressed as:

$$\begin{matrix}I = {\int }_{Δ ω} {( {E}_{h} + {E}_{g} )}^{2} d ω \\ = {\underbrace{{\int }_{Δω} ( {E}_{h} \cdot {E}_{h}^{*} + {E}_{g} \cdot {E}_{g}^{*} )}}_{{I}_{self}} + \\ {\underbrace{{\int }_{Δω} ( {E}_{h} \cdot {E}_{g}^{*} + {E}_{h} \cdot {E}_{g}^{*} ) d ω}}_{{I}_{cross}}\end{matrix} \qquad ( 6 )$$

where Δω is the linewidth of the light source.

We assume that the power spectral density of the source is a constant within the band dco and Δω and Δω·E₀²=1. The photodetector output is the time-averaged signal over the optical period. The microwave photonics system synchronizes the detection and only measures the amplitude and phase of the signal at the microwave frequency Ω. The other frequency components (e.g., the DC term and the 2Ω terms) are excluded from the vector microwave detection. The microwave frequency dependent components (i.e., the Ω dependent terms) of I_{self} and I_{cross} in Eq. (6), are given by:

$$〈 {I}_{self} 〉 {\vert}_{at Ω} = {V}_{0} [ sin ( Ω t - {Φ}_{h} ) {S}_{h} + sin ( Ω t - {Φ}_{g} ) {S}_{g} ] , where \qquad ( 7 )$$

$${S}_{h ( g )} = \frac{{γ}_{1} - {γ}_{2}}{2} {A}_{h ( g )}^{2} sin Δ ∅ \qquad ( 8 )$$

$$〈 {I}_{cross} 〉 {\vert}_{at Ω} = {V}_{0} [ sin ( Ω t - {Φ}_{h} ) {C}_{h} + sin ( Ω t - {Φ}_{g} ( {C}_{g} ] where \qquad ( 9 )$$

$${C}_{h} = \frac{A}{Δ ω} {\int }_{Δ ω} cos [ {∅}_{g} - {∅}_{h} - θ ] d ω \\ {C}_{g} = \frac{A}{Δ ω} {\int }_{Δ ω} cos [ {∅}_{g} - {∅}_{h} + θ ] d ω and \qquad ( 10 )$$

$$A = \frac{{A}_{h} {A}_{g}}{2} \cdot {[ {( {γ}_{1} + {γ}_{2} )}^{2} + {γ}_{1}^{2} + {γ}_{2}^{2} + 2 {( {γ}_{1} + {γ}_{2} )}^{2} cos ( Δ ∅ ) + 2 {γ}_{1} {γ}_{2} cos ( 2 Δ ∅ ) ]}^{\frac{1}{2}} \qquad ( 11 )$$

$$θ = arctan [ \frac{( 1 - \frac{{γ}_{2}}{{γ}_{1}} )}{1 + \frac{{γ}_{2}}{{γ}_{1}}} tan \frac{Δ ∅}{2} ] - \frac{π}{2} . \qquad ( 12 )$$

Thus, the complex frequency response S₂₁ of the system, i.e., complex reflectivity normalized with respect to the input modulation signal, is:

$${S}_{21} ( Ω ) = rect ( \frac{Ω - {Ω}_{c}}{{Ω}_{b}} ) [ {e}^{j {Φ}_{h}} ( {S}_{h} + {C}_{h} ) + {e}^{j {Φ}_{g}} ( {S}_{g} + {C}_{g} ) ] \qquad ( 13 )$$

where Ω_{b} and Ω_{c} are the bandwidth and center frequency of the microwave signal.

Here, we assume that the responsivity of the photodetector is unity.

By applying complex Fourier Transform to S₂₁(Ω), we obtain the time domain signal F(t_{z}):

$$F ( {t}_{z} ) = {Ω}_{b} [ {Ω}_{b} ( {t}_{z} - \frac{{nz}_{h}}{c} ) ] {e}^{- j {Ω}_{c} ( {t}_{z} \frac{{nz}_{h}}{c} )} \cdot ( {S}_{h} + {C}_{h} ) + {Ω}_{b} [ {Ω}_{b} ( {t}_{z} - \frac{{nz}_{h}}{c} ) ] {e}^{- j {Ω}_{c} ( {t}_{z} \frac{{nz}_{h}}{c} )} \cdot ( {S}_{h} + {C}_{h} ) \qquad ( 14 )$$

F(t_{z}) represents two pulses with time delays of nzₕ/c and nz_{g}/c respectively.

The complex values of the pulse peaks are approximately expressed as:

$$F ( \frac{{nz}_{h}}{c} ) \approx {Ω}_{b} ( {S}_{h} + {C}_{h} ) \\ F ( \frac{{nz}_{g}}{c} ) \approx {Ω}_{b} ( {S}_{g} + {C}_{g} ) \qquad ( 15 )$$

The peak values are determined by the sum of the self-products (Sₕ and S_{g}) and the cross-products (Cₕ and C_{g}). As shown in Eq. (8), Sₕ, and S_{g} vary sinusoidally as functions of the static phase difference ΔØ, but they do not change when the distance between the two reflectors changes. On the other hand, Cₕ, and C_{g} vary sinusoidally as functions of the distance between the reflectors as shown in Eq. (10). The amplitude of the sinusoidal function approaches zero as the linewidth of the light source (Δω) increases^{[1]}. When a coherent light source is used, Eq. (10) can be simplified as:

Cₕ≈A·cos[Ø_{g}−Øₕ−θ]

C_{g}≈A·cos[Ø_{g}−Øₕ+θ] (16)

The amplitudes of the two sinusoidal functions are the same, but there is a constant phase shift angle −2θ between them. θ is determined by both ΔØ and γ₂/γ₁ as shown in Eq. (12). By adjusting either ΔØ or γ₂/γ₁, we can tune the phase shift to make it close to either π/2 or −π/2 so that the quadrature phase-shift unwrapping method can be used to resolve the interference phase change of the interferometer.

A simulation started from Eq. (4) was performed to visualize the relationship between the phase shift and EOM parameters (ΔØ and γ₂/γ₁). As the two arms of EOM are commutative, we assumed |γ₁|≥|γ₂|. The reflectivity of the two reflectors were also assumed to be the same. The light source was assumed to have coherence length much larger than the OPD between the two reflectors. The amplitude of the modulation signal was set as 0.4 V, which was the value that we used in the experiments. γ₁ was set to π/4 rad/V, and γ₂/γ₁ was changed from −1 to 1 in the simulation.

FIG. 2 graphically illustrates phase shift of the interferometer as a function of γ₂/γ₁ at different ΔØ. FIG. 2 shows that at a given ΔØ, the phase shift changes monotonously as γ₂/γ₁ changes from −1 to 1. According to Eq. (12), when γ₂/γ₁=−1, the phase shift angle is always zero, so the peak amplitudes of the two pulses always change in phase as a function of the distance between the two reflectors. When γ₂/γ₁=1, the phase shift angle always equals to π, and the peak amplitudes of the two pulses change π out of phase as functions of the distance between the two reflectors. When γ₂/γ₁ is at anywhere between −1 and 1, the phase shift angle changes periodically as a function of ΔØ. The changing range is from −π to 0 when ΔØ≤0, and the range is from and 0 to π when ΔØ≥0. The phase shift can thus be adjusted by varying the γ₂/γ₁. However, γ₂/γ₁ is generally fixed for a given EOM. Therefore, the turnability of the phase shift γ₂/γ₁ is quite limited by varying γ₂/γ₁ only.

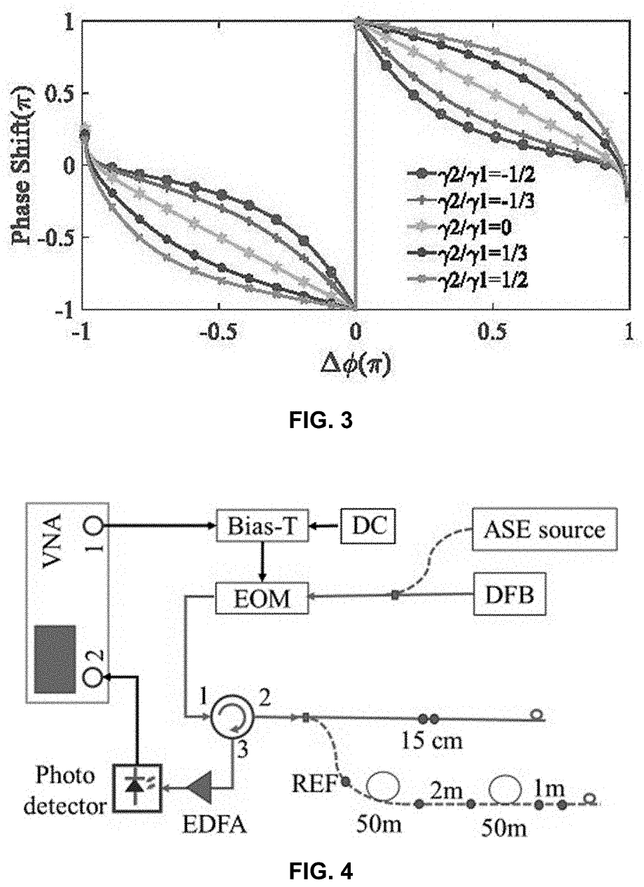

FIG. 3 graphically illustrates phase shift of the interferometer versus ΔØ under difference γ₂/γ₁. FIG. 3 shows the phase shift change versus ΔØ, when the γ₂/γ₁ equals to −½, −⅓, 0, ⅓ and ½. As predicted in Eq. (12), the phase shift decreasing monotonically as ΔØ changes from −π to π. The phase difference between the two peaks is quadrature, i.e., |2θ|=π2, where |ΔØ|=π/2 and γ₂/γ₁=0. When γ₂/γ₁<0, the quadrature phase shift is reached within the range where |ΔØ|=π/2. When γ₂/γ₁>0, the quadrature phase shift is reached within the range of π/2<|ΔØ|<π.

The simulations show good consistence to Eq. (12), when |ΔØ|<0.9π. When |ΔØ| is close to π, the calculated phase shift shows offset to the estimated value from Eq. (12). The offset is due to the linear approximation error from Eq. (5), which can be reduced by decreasing amplitude of the modulation signal. Nevertheless, both the analytical analyze and numerical simulation show that for a given EOM whose γ₂/γ₁ is fixed and γ₂/γ₁≠1, a quadrature phase shift can be obtained by adjusting the ΔØ value.

When γ₂/γ₁−1, the EOM is an ideal chirp-free intensity modulator, where only the intensity of the light is modulated. When γ₂/γ₁=1, the EOM becomes a pure phase modulator. In both cases, the phase shift is a constant at all ΔØ. When −1<γ₂/γ₁<1, both the amplitude and phase are modulated, and frequency chirp occurs during modulation^{[19]}. Because of frequency chirping, the quadrature phase shift can be reached by adjusting the EOM bias (ΔØ) by changing the bias voltage to the EOM. Therefore, we can create the two quadrature signals to demodulate the phase of the interferometer. As shown in Eqs. (12) and (16), the phase shift is independent to the location and cavity length, so the quadrature phase shift can be obtained for all the cascaded IFPIs in a CMPI system under the same bias voltage.

### Calibration

When the two signals have a phase shift angle p₀, Eq. (15) can be re-written in the following forms:

$$F ( \frac{{nz}_{h}}{c} ) = {X}_{0} + {A}_{X} cos ( p + {p}_{0} ) \\ F ( \frac{{nz}_{g}}{c} ) = {Y}_{0} + {A}_{Y} cos p \qquad ( 17 )$$

where p₀=−2θ and p=Ø_{g}−Øₕ+θ.

The two interference signals

$$F ( \frac{{nz}_{h}}{c} ) and F ( \frac{{nz}_{g}}{c} )$$

follow the trace of an ellipse as Ø_{g}−Øₕ changes, whose orbital direction is determined by whether the OPD is increasing or decreasing. We treat the parameters in Eq. (17), X₀, Y₀, A_{X}, A_{Y}, and p₀, as five unknown independent parameters. The goal of the calibration is to find these five independent parameters. Once the calibration process is completed, we can use the calibrated ellipse and the peak values to calculate the OPD change (i.e., the change of Ø_{g}−Øₕ). In this example of this disclosure, the calibration is done by changing the Ø_{g}−Øₕ, finding the respective pulse pair peak values, and fitting the data to an ellipse determined by the five parameters (X₀, Y₀, A_{X}, A_{Y}, and |p₀|). The sign of p₀ will be determined by comparing the temporal trend of the calculated p with that of the actual OPD. If they are in phase, p₀=|p₀|, otherwise p₀=−|p₀|. To achieve a good fitting, the wrapped Ø_{g}−Øₕ values should cover the entire ellipse. The OPD change can be produced by temperature variations, strain changes, or the optical carrier wavelength shifts. Because CMPI is very sensitive to the OPD, it is easy and fast to collect enough data points for calibration.

The power fluctuations of the optical carrier and the microwave source could cause failure of the calibration as well as the measurement. The power fluctuations can be compensated by adding a reference reflector into the system and normalizing the peak values to the peak amplitude of the reference reflector. The optical and microwave power terms are cancelled during the normalization, so the calibration performed based on normalized peak values is immune to the power fluctuations.

The differential polarization change could also have adverse impacts to the calibration as it changes the value A_{X}, and A_{Y}of the ellipse. This occurs when the birefringence of the fiber forming the interferometer has been altered, resulting in the changes of the interference contrast^{[3]}. The fiber birefringence is sensitive to fiber bending and twisting which should be largely avoided during calibration. The fiber birefringence is also subject to variations of environment conditions (strain, temperature, pressure, etc.). In general, differential polarization change will have a relatively small effect on the interference phase reading during measurement because polarization fading changes A_{X}, and A_{Y} but not the ratio between them. In our method, we only require a fixed ratio of A_{X}, and A_{Y}to calculate the OPD.

### EXAMPLES

To validate the proposed phase unwrapping method, we performed two sets of experiments. In the first set of experiments, a single IFPI sensor was used to verify the effect of turnability of static phase difference (ΔØ) by adjusting the EOM bias and its capability to adjust the phase shift (p₀) of the two interference signals for generating quadrature signals. After calibration, the IFPI was used for strain measurement to demonstrate the phase unwrapping method. In the second set of experiments, two cascaded IFPIs were calibrated to show the feasibility of distributed sensing.

FIG. 4 is a schematic illustration of the presently disclosed experimental setup, where “ASE” stands for amplified spontaneous emission, “DFB” stands for distributed feedback laser, “VNA” stands for vector network analyzer, and “EDFA” stands for Erbium-doped fiber amplifier.

The experiment (FIG. 4) uses light from an ASE source/DFB. The light was intensity modulated by a microwave signal via a Mach-Zehnder interferometer (MZI) type EOM (Lucent Technologies™, Model X-2623Y) by connecting the EOM to the port 1 of a vector network analyzer (VNA Agilent Technologies™E8364B; FIG. 4). The bias voltage of the EOM was provided by an external DC power supply so that it can be adjusted. The microwave-modulated light output from the EOM was launched into port 1 of a fiber circulator. Port 2 of the fiber circulator was connected to the IFPIs. The reflected signal from the IFPIs travelled back to port 3 of the circulator and was amplified by an erbium doped fiber amplifier (EDFA). The amplified optical signal was fed into a high-speed photodetector and connected to port 2 of the VNA, which measured the amplitude and phase of the signal at the microwave modulation frequency. After the VNA swept through the designated microwave bandwidth, the S₂₁ spectrum was obtained and processed to unwrap the phases of the IFPIs and calculate the OPDs.

### A. Effect of the Static Phase Difference of EOM

The static phase difference (SPD) of the EOM was tuned by varying the bias voltage at a step of 0.2 V/step from 0 V to 16 V, which covered more than one period of SPD change. The sweeping microwave bandwidth of the VNA was set from 2 GHz to 4 GHz, and the S₂₁ was recorded at each step. Two light sources with different coherence length were used in the experiments to investigate the effect of bias voltage on the time signals.

An IFPI with a cavity length of 15 cm was used in the experiment. The IFPI was formed by two weak reflectors fabricated on an SMF by femtosecond laser micromachining^{[21], [22]}. The optical reflections of the two reflectors were measured to be −35 dB, and −37 dB, respectively. The IFPI was sandwiched between two pieces of foam to minimize the environmental effects from temperature variation and vibrations.

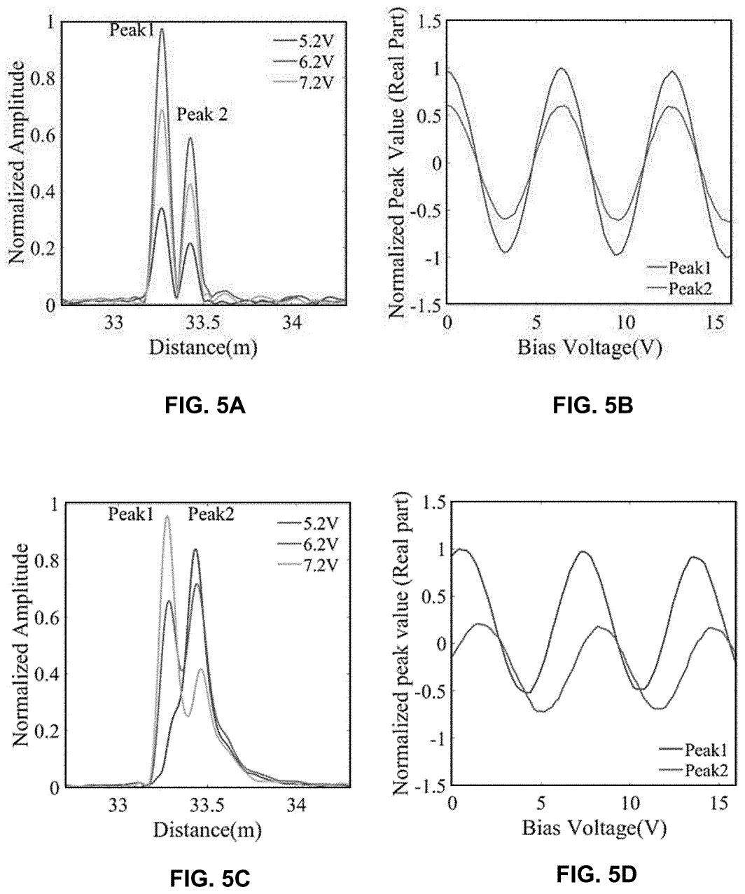

FIGS. 5A and 5C illustrate graphs of normalized time signals under different EOM bias voltages using an incoherent ASE source (FIG. 5A) and a coherent DFB laser (FIG. 5C), respectively.

FIGS. 5B and 5D illustrate graphs of normalized values (real parts of the complex values) of the pulse peaks as a function of the applied bias voltage to the EOM using an incoherent ASE source (FIG. 5B) and a coherent DFB laser (FIG. 5D), respectively.

Two types of laser sources were used to investigate the effects of the EOM bias voltage on the phase shift of the interferometer. The first experiment used an ASE source with a coherence length much smaller than the OPD of the IFPI. The amplitudes of the time domain signals from the complex Fourier transform of the received S₂₁ spectrum under three different bias voltages to the EOM are shown in FIG. 5A. The amplitudes are normalized with respect to the maximum amplitude of peak 1 for better visualization. The plots indicate that when an incoherent source is used, the amplitudes of the two peaks change proportionally. Because an incoherent light source was used, the cross-products (Cₕ and C_{g}) were close to zero. The two peak values were only functions of the self-products (Sₕ and S_{g}). Therefore, the value of two peaks changed periodically according to Eq. (10), and in phase as a function of the bias voltage as shown in FIG. 5B.

In the second experiment, a coherent DFB laser source, with the center wavelength of 1554 nm and a linewidth of 5 MHz, was used to study the effects of the EOM bias voltage on the phase shift of the two peaks. The coherence length of the DFB laser was much larger than the OPD of the IFPI. In time domain, the amplitudes of two peaks did not change proportionally due to the bias voltage change when a coherent source is used (FIG. 5C). Although the value of two peaks varies periodically as a function of the applied bias, two curves had a clear phase shift (FIG. 5D).

As shown in Eq. (15), the pulse peaks are composed by self-products (Sₕ and S_{g}) and the cross-products (Cₕ and C_{g}). The self-products (Sₕ and S_{g}) are sinusoidal functions of the static phase separation (ΔØ) imposed by the EOM as given in Eq. (8), which varies as a function of the bias voltage. The cross-products (Cₕ and C_{g}) are governed by the optical interference of the reflected waves and change their values as functions of ΔØ when the coherence length of the light source is longer than the OPD of the IFPI^{[1]}. Also indicated in Eq. (16), the two peaks have a phase shift changing as a result of tuning the EOM bias.

The phase shift p₀ of the two interference signals at different bias was also investigated experimentally. The bias DC voltage of the EOM was changed from 0 V to 8 V at the step size of 1 V/step. At each bias voltage, a total of 101 S₂₁ spectra were taken. The time interval was set to be 10 seconds between two consecutive S₂₁ acquisitions. The intermediate frequency bandwidth (IFBW) of the VNA was set to be 10 kHz, and the total sampling points were 3,201. Each S₂₁ acquisition took about 0.377 seconds, within which the OPD of the IFPI was assumed to be unchanged.

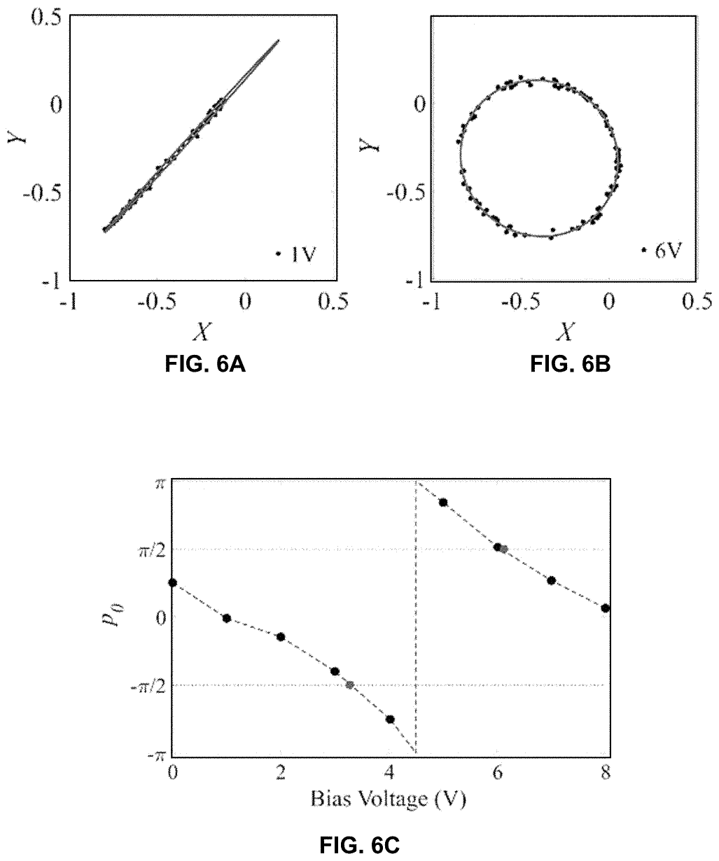

FIGS. 6A and 6B illustrate graphs of normalized two peaks (black) and fitted ellipses (gray) under the bias voltages of 1 V (FIG. 6A) and 6 V (FIG. 6B), respectively. FIG. 6C illustrates a graph of phase shift p₀ calculated based on the fitted ellipse (FIG. 6B) at different bias voltages.

It is estimated that a temperature change of about 3° C. will result in the interference phase change of 2π for the 15-cm long IFPI[¹]. In the experiment, we slightly increased the temperature of the IFPI by placing a heat source close to the fiber, resulting in the gradual increasing of the OPD. Once enough temperature fluctuations were created, the obtained time peak (real part) from the Fourier transform of the S₂₁ spectrum was normalized to the maximum peak amplitude. The normalized values were then fitted into an ellipse. The sign of p₀ was determined by comparing the temporal trend of the calculated p with that of the actual OPD, i.e., when the calculated p increased as a function of time, p₀=|p₀|, otherwise, p₀=|p₀|.

The fitted ellipses under the bias voltages of 1 V and 6 V are shown in FIGS. 6A and 6B, respectively. The two ellipses have similar center offsets but different eccentricities which are determined by the phase shift p₀. The black dots in FIG. 6C show the phase shift p₀ calculated from the fitted ellipses under eight different EOM bias voltages−p₀ changes gradually as a function of the EOM bias voltage. As estimated from the curve shown in FIG. 6C, the phase shift was close to −π/2 when the bias voltage was adjusted to about 3.3V, and it was close to π/2 when the bias voltage was adjusted to about 6.1 V. The results indicate that it is possible to tune the interference to a close-to-quadrature condition by adjusting the EOM bias voltages.

### B. Phase Demodulation

Once a close-to-quadrature condition is reached, the interference phase (thus the OPD) change of the interferometer can be demodulated and unwrapped using the well-known quadrature method. To confirm this, we used strain measurement as an example to demonstrate the phase demodulation.

The strain sensitivity of the individual IFPI can be calculated from Eq. (15). If we assume that the interferometer has a cavity length of L, the phase difference of the two reflected wave is:

Ø_{OPD}=O_{g}−Oₕ=2nLω/c (18)

By taking the partial derivative of the phase with respect to the cavity length L in Eq. (18), we have:

$$\frac{\partial {∅}_{OPD}}{\partial L} = 2 n ω / c \qquad ( 19 )$$

By substituting the strain definition (ε=δL/L) and effective strain-optic coefficient P_{eff}^{[23]} into Eq. (19), we obtain:

δØ_{OPD}=2(1−P_{eff})εLnω/c (20)

Eq. (20) indicates that the change of phase difference δØ_{OPD} is linearly proportional to the applied strain, and the strain sensitivity δØ_{OPD}/ε is proportional to the initial cavity length L.

In the experiment, the two fiber ends of the IFPI were glued onto two motorized translation stages (PM500, Newport) respectively. The two fixing points were separated by 1.7 m and the IFPI was positioned in the middle of the two stages. Axial positive strains were applied to the IFPI by moving one stage at 1 μm (corresponding to about 0.5882 με) per step. After a total of 50 steps (corresponding to a total strain of about 29.41 με), the stage was moved backwards at 1 um/step to decrease the applied strain. The DC bias voltage of the EOM was set to be 3.3 V, where the phase shift was close to −π/2.

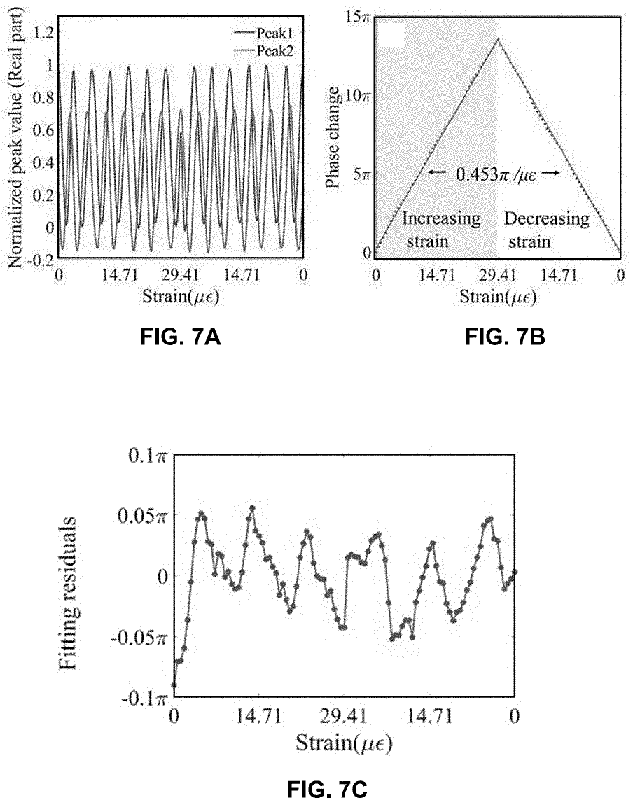

The normalized peak values (real part) of the two pulses were plotted as functions of the applied strains in FIG. 7A. The two peak values change sinusoidally as the strain changes and multiple fringes would be seen because total interference phase changed more than 2π. An abrupt change happened when the applied strain started decreasing after it reached the maximum strain (29.41 με). It also can be seen that there was a constant phase delay between the two peak values. When one curve reached its peak, the other was close to the mean value, indicating a phase difference close to π/2. The phase shift (p₀) between the two peak values was −0.4935π, calculated based on the ellipse fitting.

The interferometric phase change induced by the applied strain was calculated by using the two quasi-quadrature phase-shifted signals. The unwrapped phase changes as a function of the applied strain are plotted as dots in FIG. 7B, where the interferometric phase change is proportional to the applied strain. When the strain increased, the phase increased accordingly, and vice versa. The quadrature phase unwrapping also successfully differentiated the direction of the applied strain. The solid line in FIG. 7B shows the linear fitted strain vs. phase change curve. The slope of the fitted experimental data was 0.453 π/με, which was close to the calculated strain sensitivity 0.455 π/με from Eq. (20), where we assumed P_{eff}=0.204^{[24]}.

FIG. 7C illustrates a graph of fitting residuals of the unwrapped interference phase. The deviations are bounded between ±0.05π, which might be the combined contributions of the stage movement errors, temperature variations, and phase delay calculation error during ellipse fitting^{[5], [25]}.

### C. Phase Demodulation of Distributed Sensors

One unique feature of CMPI is its capability for distributed sensing. Here, we used two cascaded IFP Is to demonstrate the distributed sensing capability of the CMPI. The experiment arrangement is shown in FIG. 4, where the cavity lengths of the two IFPIs were 1 m and 2 m respectively and separated by a fiber of about 50 m in length. A single reflector was placed about 50 m away from the first sensor as a reference to compensate laser power fluctuations during experiments. The IFPIs were loosely taped on an optical table in order to respond to the room temperature changes. The EOM bias voltage was set to be 3.3 V, which would result in a close-to-quadrature phase shift as shown previously.

The sweeping microwave bandwidth of the VNA was from 2 GHz to 2.5 GHz. The sampling points number was 3201, but the IFBW of VNA was set as 30 kHz to increase the sampling rate. Each measurement took about 115.236 ms, and a dwelling time of 1 second was applied between two adjacent acquisitions of the S₂₁ spectrum. A total of 201 S₂₁ spectra was taken.

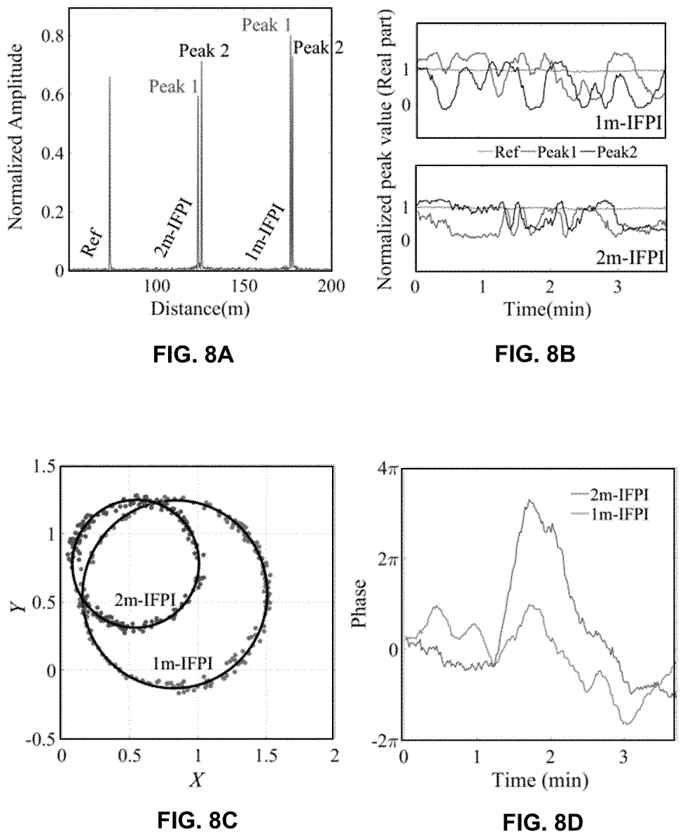

Typical amplitudes of the time domain signals of the distributed sensors are shown in FIG. 8A, where the first pulse is the reference reflector, and the two pairs of pulses are from the two cascaded IFPIs. The temporal variations (functions of time) of the peak values of these pulses are plotted in FIG. 8B, where the upper and lower plots are for the 1 m-IFPI and 2 m-IFPI, respectively. The reference peak was relatively stable during the entire experiment but the peak values of the two IFPIs changed significantly as a result of temperature variations.

FIG. 8C illustrates a graph of fitted ellipses of the two cascaded IFPIs, and FIG. 8D illustrates a graph of unwrapped interference phases of the two IFPIs as functions of time.

More specifically, the peak values of the paired pulses of the IFPIs are plotted in FIG. 8C as dots where the fitted two ellipses are also shown. The center position of the ellipse is determined by the difference in reflectivity of the paired reflectors that form the IFPI. After normalization with respect to the reference reflection, the centers are constants and immune to the power fluctuation from the light source. The phase shifts are −0.4975π for the 2 m-IFPI and −0.4964π for the 1 m-IFPI, calculated based on the fitted ellipses. Theoretically, the phase shift should be the same for all the cascaded interferometers because it is determined by the DC bias voltage of the EOM. The slight difference in phase shift of the two IFPIs is due to measurement errors. The length of the major axis of the ellipse was determined by the interference contrast of the IFPI. The fitted ellipse of the 2 m-IFPI had a smaller major axis because of a lower interference contrast (which could be caused by polarization fading) as the longer cavity length the larger state of polarization difference in reflections of the two reflectors^{[3]}.

The unwrapped interference phase as a function of measurement time for both IFPIs was calculated using the calibrated parameters and plotted in FIG. 8D. In general, the two interferometers showed similar phase changing trends with minor differences because they were located at different places on the optical table. The phase change of the 2 m-IFPI was larger than that of the 1 m-IFPI due to its longer cavity, and thus, higher sensitivity. In addition, the quadrature phase unwrapping successfully resolved a phase change larger than 2π and differentiated the directions of phase changes in the cascaded IFPIs.

In summary, we report a new quasi-quadrature phase-shifted signal-processing method to demodulate the interference phases of cascaded IFPIs in the coherent microwave photonic interferometric distributed sensing system. Our theoretical and experimental investigations reveal that the phase shift in an IFPI can be changed by adjusting the DC bias voltage of the EOM based on the chirping effect. The phase shift can be calculated by fitting the two peak values of the IFPI into an ellipse. A quasi-quadrature phase shift can be created to demodulate the interference phase. The method has been demonstrated for strain sensing, showing good phase unwrapping linearity, sensitivity, and direction differentiation capability.

Because the phase shift is determined by the bias voltage of the EOM, the cascaded IFPIs have the same phase shift, which significantly reduces the complexity in distributed sensing. Two cascaded IFPIs of different cavity lengths have been used to demonstrate that the quasi-quadrature phase shift-based phase unwrapping can successfully resolve multiplexed IFPIs for distributed temperature sensing. Standalone reference reflectors can be flexibly arranged into the system to compensate for fluctuations caused by laser power instability and fiber loss variations along the transmission path. The number of IFPIs that can be cascaded is limited by the reflectivity of the IFPIs, loss of the fiber, and noise level of the detection system. The reflectors fabricated by the ultrafast laser have a typical reflectivity in the range of −35 to −40 dB. The current system has a detection limit of about −55 dB. Without extra optical amplifications, we can demodulate a few hundred IFP Is simultaneously using the current system.

As IFPIs can be easily encoded to measure various quantities such as strain and temperature, we expect that the new homodyne quadrature phase-shift signal processing method will have many applications where high sensitivity, large dynamic range, and distributed sensing are required. It should be noted that as the changes of strain, temperature, and laser frequency all contribute to the interference phase change of the IFPIs, the cross-sensitivity needs to be considered in real applications. When this method is used for long-term measurements, the optical frequency of the laser needs to be stabilized or monitored/compensated because the drift of the laser frequency directly causes a phase shift to the cascaded interferometers.

While the present subject matter has been described in detail with respect to specific example embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

### REFERENCES

[1] L. Hua, Y. Song, B. Cheng, W. Zhu, Q. Zhang, and H. Xiao, Coherence-length-gated distributed optical fiber sensing based on microwave-photonic interferometry,” Opt. Express, vol. 25, no. 25, pp. 31362-31376,2017.

[2] L. Murdoch et al., “Measuring and interpreting borehole strainmeter data to improve CO2 storage,” in American Geophysical Union, Fall Meeting, 2017, p. #S51C-0613.

[3] D. W. Stowe, D. R. Moore, and R. G. Priest, “Polarization Fading in Fiber Interferometric Sensors,” IEEE Trans. Microw. Theory Tech., vol. 30, no. 10, pp. 1632-1635,1982.

[4] T. Požar, P. Gregorcic, and J. Možina, “A precise and wide-dynamic-range displacement-measuring homodyne quadrature laser interferometer,” Appl. Phys. B Lasers Opt., vol. 105, no. 3, pp. 575-582,2011.

[5] T. Pozar and J. Mozina, “Enhanced ellipse fitting in a two-detector homodyne quadrature laser interferometer,” Meas. Sci. Technol., vol. 085301, p. 085301, 2011.

[6] M. A. Zumberge, J. Berger, M. A. Dzieciuch, and R. L. Parker, “Resolving quadrature fringes in real time,” Appl. Opt., pp. 771-775, 2004.

[7] K. a Murphy, M. F. Gunther, a M. Vengsarkar, and R. O. Claus, “Quadrature phase-shifted, extrinsic Fabry-Perot optical fiber sensors.,” Opt. Lett., vol. 16, no. 4, pp. 273-275, 1991.

[8] S. K. Sheem, “Optical fiber interferometers with [3×3] directional couplers: Analysis,” J. Appl. Phys., vol. 52, p. 3865, 1981.

[9] B. Qi, D. Winder, and Y. Liu, “Quadrature phase-shifted optical demodulator for low-coherence fiber-optic Fabry-Perot interferometric sensors,” Opt. Express, vol. 27, no. 5, pp. 7319-7329, 2019.

[10] J. Jiang et al., “Optical fiber Fabry-Perot interferometer based on phase-shifting technique and birefringence crystals,” Opt. Express, vol. 26, no. 17, pp. 21606-21614, 2018.

[11] Z. Ren, J. Li, R. Zhu, K. Cui, Q. He, and H. Wang, “Phase-shifting optical fiber sensing with rectangular-pulse binary phase modulation,” Opt. Lasers Eng., vol. 100, no. 2018, pp. 170-175, 2018.

[12] A. J. Sutton, O. Gerberding, G. Heinzel, and D. A. Shaddock, “Digitally enhanced homodyne interferometry,” Opt. Express, vol. 20, no. 20, pp. 22195-22207, 2012.

[13] Z. Cheng et al., “A Novel Demodulation Scheme of Fiber-Optic Interferometric Sensor Based on FM SSB Signal,” IEEE Photonics Technol. Lett., vol. 31, no. 8, pp. 607-610, 2019.

[14] A. Hartog, “Differential phase measuring DVS,” in An Introduction to Distributed Optical Fibre Sensors, 2017, pp. 239-256.

[15] Z. Wang et al., “Coherent ϕ-OTDR based on I/Q demodulation and homodyne detection,” Opt. Express, vol. 24, no. 2, p. 853, 2016.

[16] J. Song, W. Li, P. Lu, Y. Xu, L. Chen, and X. Bao, “Long-Range High Spatial Resolution Distributed Temperature and Strain Sensing Based on Optical Frequency-Domain Reflectometry,” IEEE Photonics J., vol. 6, no. 3, pp. 1-8, 2014.

[17] A. Masoudi, M. Belal, and T. P. Newson, “A distributed optical fibre dynamic strain sensor based on phase-OTDR,” Meas. Sci. Technol., vol. 24, no. 8, 2013.

[18] Z. Sha, H. Feng, and Z. Zeng, “Phase demodulation method in phase-sensitive OTDR without coherent detection,” Opt. Express, vol. 25, pp. 4831-4844, 2017.

[19] C. E. Rogers, J. L. Carini, J. A. Pechkis, and P. L. Gould, Characterization and compensation of the residual chirp in a Mach-Zehnder-type electro-optical intensity modulator.,” Opt. Express, vol. 18, pp. 1166-1176, 2010.

[20] M. Abramowitz and I. Stegun, “Bessel Functions of Integer Order,” in Handbook of Mathematical Functions With Formulas, Graphs, and Mathematical Tables, 1972, p. 360.

[21] Y. Song et al., “An IFPI Temperature Sensor Fabricated in an Unstriped Optical Fiber with Self-Strain-Compensation Function,” J. Sensors, vol. 2016, p. 6419623, 2016.

[22] Z. Chen, G. Hefferman, L. Yuan, Y. Song, and T. Wei, “Ultraweak Waveguide Modification with Intact Buffer Coating Using Femtosecond Laser Pulses,” IEEE Photonics Technol. Lett., vol. 27, no. 16, pp. 1705-1708, 2015.

[23] C. D. Butter and G. B. Hocker, “Fiber optics strain gauge.,” Appl. Opt., vol. 17, no. 18, pp. 2867-9, September 1978.

[24] L. Hua, Y. Song, J. Huang, X. Lan, Y. Li, and H. Xiao, “Microwave interrogated large core fused silica fiber Michelson interferometer for strain sensing,” Appl. Opt., vol. 54, no. 24, pp. 7181-7187, 2015.

[25] C. Wu and C. Su, “Nonlinearity in measurements of length by optical interferometry,” Meas. Sci. Technol., vol. 7, pp. 62-68, 1996.

What is claimed is:

1. Methodology for signal processing for Coherence Microwave Photonic Interferometry (CMPI) sensors, including demodulating the optical interference phase of cascaded individual optical fiber intrinsic Fabry-Perot interferometric (IFPI) sensors in a coherent microwave-photonic interferometry (CMPI) distributed sensing system, including performing phase demodulation by frequency chirping.

2. Methodology according to claim 1, further comprising using the chirp effect of an electro-optic modulator (EOM) to create a quasi-quadrature optical interference phase shift between two adjacent pulses which correspond to two adjacent reflection points in the time domain.

3. Methodology according to claim 2, further including controlling the phase shift by adjusting a bias voltage that is applied to the EOM.

4. Methodology according to claim 1, further comprising conducting frequency domain measurements.

5. Methodology according to claim 4, further comprising converting the frequency domain measurements to a time domain signal at a known location by complex Fourier transform, with the values of the time domain signal pulses a function of the optical path differences (OPDs) of the distributed IFPIs, which are used to read the displacement between pairs of measurement reflectors.

6. Methodology according to claim 5, further comprising:
while the microwave frequency is swept with a constant speed, recording in the complex microwave spectrum the sub-scan rate interference intensity modulation due to acoustic/vibration;
converting the created intensity modulation into paired side lobes to the respective time domain pulse; and
determining the vibration frequency and amplitude at each location from the respective time pulses and side lobes.

7. Methodology according to claim 1, wherein the cavity length of each IFPI is at least 1 m long.

8. Methodology according to claim 3, wherein the interference phase is calculated by performing an elliptical fit of the phase shift.

9. Methodology according to claim 8, wherein the interference phase change is proportional to the optical path difference (OPD) change of the interferometer, and the sign of the interference phase change is used to differentiate increase or decrease of the OPD.

10. Methodology according to claim 1, further comprising using the CMPI sensors for assessing structural health of buildings; civil infrastructure, including bridges, roads, or dams; for monitoring geologic hazards, including landslides or earthquakes; and for assessing safety and monitoring of underground resource management, including oil and gas production, geothermal energy, carbon storage, water production or remediation; and for characterizing subsurface, or surface structures using seismic or acoustic methods.

11. A method of using homodyne quadrature detection to demodulate the phase of cascaded interferometers in a Coherence Microwave Photonic Interferometry (CMPI) distributed sensing system, comprising using the chirp effect of an electro-optic modulator (EOM) to create the two quadrature interference signals of the cascaded interferometers.

12. The method according to claim 11, further including tuning phase shift as desired by adjusting the bias of the EOM.

13. The method according to claim 12, wherein the interference phase change is proportional to the optical path difference (OPD) change of the interferometer, and the sign of the interference phase change is used to differentiate increase or decrease of the OPD.

14. A coherence length gated microwave photonic interferometry (CMPI) based distributed sensing system for accurately measuring static and dynamic changes of physical, chemical, or biological property, comprising:
an optical fiber with a series of weak reflectors along it, with any two of such reflectors forming a Fabry Perot interferometer (FPI) recording the localized change in distance between the two reflectors in the form of optical interference;
a coherent microwave photonics interrogation unit configured to prepare a microwave-modulated low-coherence light wave from a light source; and
one or more processors programmed to:
control the sensing system to scan microwave frequencies to obtain complex microwave spectrum frequency domain measurements.

15. The CMPI based distributed sensing system according to claim 14, wherein the one or more processors are further programmed to:
convert the frequency domain measurements to a time domain signal at a known location by complex Fourier transform, with the values of the time domain signal pulses a function of the optical path differences (OPDs) of the distributed FPIs, which are used to read the displacement between pairs of measurement reflectors;
while the microwave frequency is swept with a constant speed, record in the complex microwave spectrum the sub-scan rate interference intensity modulation due to acoustic/vibration; and
convert the created intensity modulation into paired side lobes to the respective time domain pulse.

16. The CMPI based distributed sensing system according to claim 14, wherein the one or more processors are further programmed to read the vibration frequency and amplitude at each location from the respective time pulses and side lobes.

17. The CMPI based distributed sensing system according to claim 16, wherein the measurement resolution of the sensing system is proportional to the separation distance between the two reflectors which form the FPI.

18. The CMPI based distributed sensing system according to claim 17, wherein the sensing system has a sensing resolution of 1 part per billion (ppb) when the cavity length of FPI exceeds 1 m long.

19. The CMPI based distributed sensing system according to claim 16, wherein the coherence length of the light source acts as a gate, which only allows the reflectors with separation distance smaller than the coherence length to contribute to the amplitude of the time domain pulse at each respective location, to achieve distributed sensing.

20. The CMPI based distributed sensing system according to claim 16, further comprising:
an external interferometer (EI) with cavity length equals to the FPIs; and
wherein the coherence length of the light source covers the OPD difference between the EI and FPI, whereby the coherence length of the light wave can be smaller than the OPD of each FPI, so that no spacing is needed between adjacent FPIs to perform distributed sensing.

21. The CMPI based distributed sensing system according to claim 14, further comprising:
an electro-optic modulator (EOM) having a chirp effect mode; and
wherein the one or more processors are further programmed to conduct phase unwrapping by using the frequency chirping mode of the EOM.

22. The CMPI based distributed sensing system according to claim 21, wherein:
the frequency chirping comprises a chirp effect of the electro-optic modulator (EOM) utilized to create two interference signals in quadrature for each FPI; and
the one or more processors are further programmed to unwrap the phase of each FPI, which has linear relationship with OPD of the FPIs.

23. The CMPI based distributed sensing system according to claim 21, wherein the electro-optic modulator (EOM) is operative to create a quasi-quadrature optical interference phase shift between two adjacent pulses which correspond to two adjacent reflection points in the time domain.

24. The CMPI based distributed sensing system according to claim 14, wherein the one or more processors are further programmed to record frequency scanning results, and conduct Fourier transform of the results in time domain to reveal dynamic information, for distributed acoustic sensing.
